(19) United States
(12) Patent Application Publication
(10) Pub. No.: US 2014/0365699 A1
(43) Pub. Date: Dec. 11, 2014

(54) ADAPTER CARD FOR THIN COMPUTING DEVICES

(71) Applicant: Allied Telesis Holdings Kabushiki Kaisha, Tokyo (JP)

(72) Inventor: Douglas D. Barga, Bellevue, CA (US)

(21) Appl. No.: 13/915,380

(22) Filed: Jun. 11, 2013

(51) Int. Cl. G06F 13/40

(52) U.S. Cl. CPC G06F 13/409
USPC 710/301

(57) ABSTRACT

A device comprising an adapter card and a motherboard interface for coupling the adapter card to a motherboard. In some embodiments, the motherboard interface may be configured to transmit data between the adapter card and the motherboard. In some embodiments, the motherboard interface may be configured to supply power from the motherboard to the adapter card. In some embodiments, the device further comprises an external interface for coupling the adapter card to an external environment of a system associated with the motherboard. In some embodiments, the external interface is a non-peripheral connect interface slot and is configured to transmit data between the external environment of the system and the adapter card.

### BACKGROUND

A number of peripheral component interconnect (PCI) slots are reduced, and in certain instances eliminated, as demand for thin computing devices also known as thin client devices is increased. Unfortunately, reducing the number of PCI slots results in reduction or elimination of features supported by the PCI slots, e.g., fiber cards, graphic cards, etc.

### SUMMARY

Accordingly, there is a need to provide functionalities of cards supported by PCI slots in the absence of PCI slots. For example, there is a need to provide adapter cards in a thin client device without PCI slots or with reduced number of PCI slots where the adapter cards are incorporated within the thin client without using the PCI slots. In some embodiments, an adapter card may be incorporated in a computing device by housing the adapter card in an unused hard disk drive carrier, an optical drive, floppy drive, or any housing configured to store an electronic component. Accordingly, features of an adapter card may be included in a computing device without the use of a PCI slot.

In some embodiments, an adapter card may be coupled to a motherboard interface, such as an express miniboard. The express miniboard may be configured to facilitate communication between the adapter card and the motherboard. The connections coupling the adapter card to the motherboard is different from the PCI slot and may use different configurations, standards, voltages, etc. In order to provide the functionalities that are supported by PCI slots, certain modifications to the adapter cards may be made. For example, the adapter card may be modified to support remote access features, such as a wake on local area network (WoL). In one embodiment, a detection circuitry on the adapter board may determine the operating state of the thin client, e.g., on state or off state, based on a voltage supplied by the motherboard interface to the adapter board.

In some embodiments, an adapter card may be coupled to an external interface different from the PCI slot. The external interface facilitates data communication between the adapter card and the external environment of the thin client. In some embodiments, the external interface may include internal media cables, such as fiber optic cables, and connectors. The connectors may couple the internal media cables with external cables of the thin client to facilitate communication between the adapter card and the external environment. As such, the adapter card facilitates communication with an external environment without using a PCI slot.

In some embodiments, a device may comprise an adapter card and a motherboard interface for coupling said adapter card to a motherboard. In some embodiments, the motherboard interface may be configured to transmit data between the adapter card and the motherboard. In some embodiments, the motherboard interface may be configured to supply power from the motherboard to the adapter card. In some embodiments, the device may further comprise an external interface for coupling the adapter card to an external environment of a system associated with the motherboard. In some embodiments, the external interface is a non-peripheral connect interface (PCI) slot. In some embodiments, the external interface is configured to transmit data between said external environment of said system and said adapter card.

In some embodiments, the motherboard interface may comprise an express miniboard. In some embodiments, the adapter card may be positioned in a non-PCI slot location. In some embodiments, the adapter card comprises a network data transmitter module that may be configured to communicate networking data between the external environment of the system and the adapter card via emitting light signals. In some embodiments, adapter card may comprise a fiber optic module.

In some embodiments, the adapter card may comprise a operating mode detection unit configured to determine an operating state of said motherboard. In some embodiments, the adapter card may comprise a component configured to determine whether to perform a wake on local access network (WoL) operation.

In some embodiments, the adapter card may comprise a voltage detector, a controller unit and a wake on local access network (WoL) unit. In some embodiments, a voltage detector may be configured to determine whether a first voltage or a second voltage is present at the motherboard interface. In some embodiments, a controller unit may be configured to change the first voltage to a third voltage in response to determining the presence of the first voltage. In some embodiments, the first voltage differs from the third voltage. In some embodiments, the controller unit may be configured to maintain the second voltage in response to detection of the second voltage by the voltage detector. In some embodiments, WoL unit configured to initiate a WoL operation in response to receiving the second voltage. In some embodiments, the WoL unit is configured to disable the WoL operation in response to receiving the third voltage from the controller unit. In some embodiments, the adapter card may be configured to determine whether the motherboard is in an on state or an off state. In some embodiments, the adapter card may be further configured to initiate WoL operation in response to determining that the motherboard is in an off state.

In some embodiments, a method comprises communicating data between a motherboard and an adapter card of a device via a motherboard interface, receiving power from the motherboard to supply power the adapter card, and communicating data between the adapter card and an external environment to a system associated with the motherboard via an external interface. In some embodiments, the external interface is a non-PCI slot.

In some embodiments, the method may further comprise emitting light signals to communicate networking data between the adapter card and the external environment. The method may further comprise determining an operating state associated with the motherboard, and determining whether to perform a wake on local access network (WoL) operation based on the operating state in some embodiments.

In some embodiments, the method may comprise determining whether a first voltage or second voltage is present at the motherboard coupled to the motherboard interface, changing the first voltage to a third voltage in response to determining presence of the first voltage. In some embodiments, the first voltage differs from the third voltage. In some embodiments, the method further comprise maintaining said second voltage in response to determining presence of said second voltage, and initiating a wake on local access network (WoL) operation in response to determining presence of said second voltage.

In some embodiments, the method may further comprise determining that the device is in an on state responsive to detecting a first voltage level at the motherboard interface coupled to the motherboard, and determining that the device is in an off state responsive to detecting a second voltage level at the motherboard interface coupled to the motherboard.

In some embodiments, a device may comprise a peripheral component configured to be positioned in a non-peripheral connect interface (PCI) slot location. In some embodiments, the peripheral component facilitates communication between a system and an external environment. In some embodiments, the system comprises a motherboard associated with the device. In some embodiments, the external environment is an environment external to the system. In some embodiments, the device may further comprise a motherboard interface configured to couple the peripheral component to the motherboard. In some embodiments, the motherboard interface is configured to communicate data between the peripheral component and the motherboard. In some embodiments, the motherboard interface is configured to supply power to the peripheral component.

These and various other features and advantages will be apparent from a reading of the following detailed description.

### BRIEF DESCRIPTION OF DRAWINGS

Various embodiments are illustrated by way of example, and not by way of limitation, in the figures of the accompanying drawings and in which like reference numerals refer to similar elements.

FIG. 1 shows a computing device configured to house an adapter card according to one embodiment.

FIG. 2 shows a computing device configured to house a network adapter according to one embodiment.

FIG. 3 shows an external interface according to one embodiment.

FIG. 4 shows an operating mode detection unit according to one embodiment.

FIG. 5 shows a operating mode detection unit and a controller according to one embodiment.

FIG. 6 shows an exemplary flow diagram for data communication of an adapter card according to one embodiment.

FIG. 7 shows an exemplary flow diagram to determine an operational state of a computing device to initiate a wake on local access network (WoL) operation according to one embodiment.

### DETAILED DESCRIPTION

Reference will now be made in detail to various embodiments, examples of which are illustrated in the accompanying drawings. Various embodiments described are exemplary and for illustration purposes. As such, it will be understood that these various embodiments are examples and not intended to limit the invention. On the contrary, the embodiments are intended to cover alternatives, modifications, and equivalents, which may be included within the scope of the invention as construed according to the appended Claims. Furthermore, in the following detailed description of various embodiments, numerous specific details are set forth in order to provide a thorough understanding of the invention. However, it will be evident to one of ordinary skill in the art that the invention may be practiced without these specific details. In other instances, well known methods, procedures, and components have not been described in detail as not to unnecessarily obscure aspects of the embodiments.

Some portions of the detailed descriptions that follow are presented in terms of procedures, methods, flows, logic blocks, processing, and other symbolic representations of operations performed on a computing device or a server. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device or a processor. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “communicating,” “determining,” “receiving,” “sending,” “transmitting,” “emitting,” “changing,” “initiating,” “processing,” “computing,” “adjusting,” “storing,” “configuring,” “providing,” “accessing,” “performing,” “maintaining,” “enabling,” “disabling,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

There is an increasing need for thin client devices to incorporate functionalities of adapter cards supported by the PCI slots. However, many thin client devices have limited PCI slots, e.g., less than two PCI slots, to include the features of an adapter card. As such, there is a need to incorporate an adapter card in a device without the use of a PCI slot. In some embodiments, an adapter card may be incorporated in a computing device by housing the adapter card in an unused hard disk drive carrier, an optical drive, floppy drive, or any housing configured to store an electronic component. Accordingly, features of an adapter card may be included in a computing device without the use of a PCI slot.

In some embodiments described herein, the adapter card may be coupled to a motherboard interface, such as an express miniboard, that facilitates communication between a motherboard and the adapter card. The motherboard interface may provide an alternative to a PCI communication bus of a PCI slot to transmit data between the motherboard and the adapter card. In this way, the motherboard interface provides a mechanism that allows features of the adapter card to be incorporated into a computing device without the use of a PCI slot.

Some modifications may need to be made to the adapter card to provide the functionalities supported by PCI slots without using the PCI slots. For example, the adapter card may include a wake on local area network (WoL) unit to support an WoL feature. In some embodiments, the WoL unit may be configured to determine the amount of voltage supplied by the motherboard interface, change the voltage as required, determine the operating state of a device, and initiate a WoL operation accordingly. In some embodiments, the adapter card may be coupled to an external interface different from a PCI slot. The external interface may be configured to transmit data between the external environment and the adapter card. In some embodiments, the external interface may comprise of media cables and connectors that may be connected to external cables, such as fiber optic cables or Ethernet cables, to facilitate communication between the adapter card and the external environment without using a PCI slot.

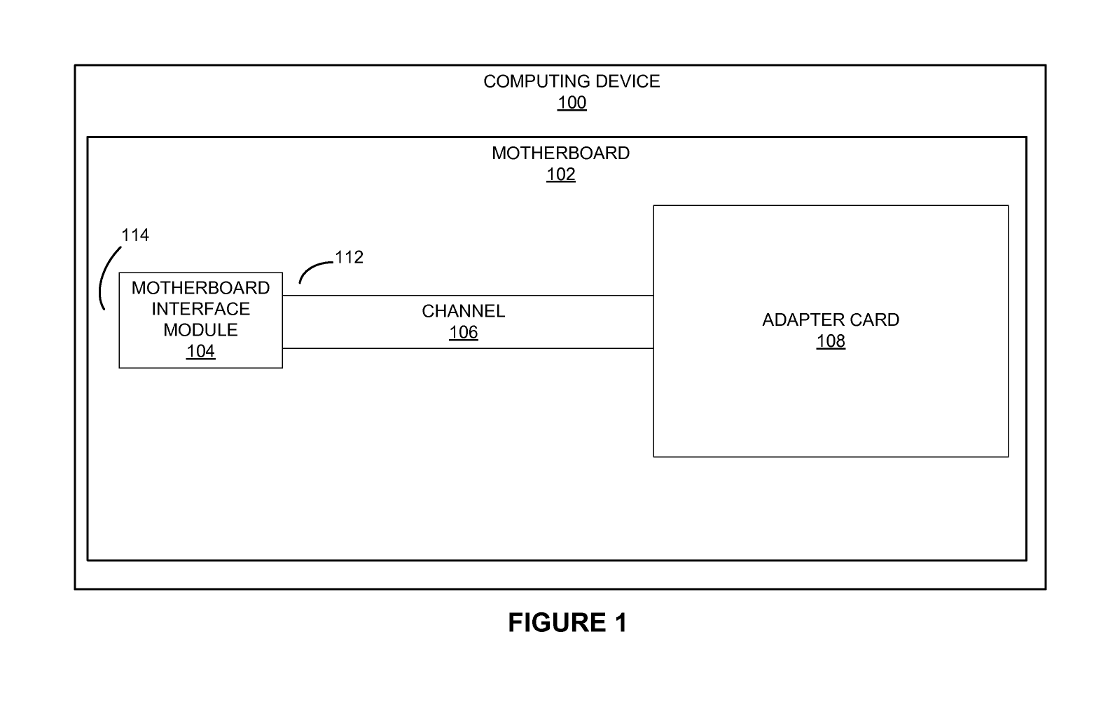

Referring now to FIG. 1, a computing device configured to house an adapter card according to one embodiment is shown. In some embodiments, computing device 100 may be a thin client device with reduced number of PCI slots, e.g., fewer than two PCI slots. Although many of the features are illustrated with reference to PCI slots, it is appreciated that the discussion of PCI slots is exemplary and is not intended to limit the scope of the embodiments. For example, in some embodiments, the features described herein may be applicable to thin clients with reduced number of PCIe slots, PCI-X slots, or any other expansion slots. The adapter cards according to some embodiments may use appropriate protocols of the corresponding slot, e.g., PCI slots, PCI-X slots, PCIe slots, or any other expansion slots, to enable the adapter card to function as if it was inserted into the PCI slot even though it is not.

In some embodiments, the computing device 100 includes a motherboard 102, a motherboard interface module 104, a channel 106, and an adapter card 108. Although FIG. 1 illustrates a few components of the computing device 100, it is appreciated that computing device 100 may include other components (not shown) to ensure proper functionality.

In some embodiments, the computing device 100 is configured to house an adapter card 108 and incorporate its features without inserting the adapter card 108 in a PCI slot. In some embodiments, the adapter card 108 may be a fiber optics adapter, a graphics card, a network adapter, a sound card, or any peripheral component.

Instead of inserting the adapter card 108 into a PCI slot, the adapter card 108 may be housed in a different location within the computing device 100. In some embodiments, the adapter card 108 is housed in an unused or underutilized location of the computing device. For example, a conventional thin client device may not include a hard drive. As such, a hard drive carrier that would house the hard drive remains empty and unused. In this example, the adapter card 108 may be housed in the hard drive carrier (not shown) of the computing device 100 and the hard drive carrier may be placed over the motherboard 102. In some embodiments, adapter card 108 may be housed in an optical drive, a floppy drive, or housed in any unused region of the computing device 100.

It is appreciated that in some embodiments, the adapter card 108 may need to be modified to conform to size and height of the housing. For example, if the adapter card 108 is housed in a two and half inches (2½″) hard disk drive carrier, then the form and the printed circuit board assembly (PCBA) of the adapter card may be modified to fit within the carrier.

Further, although FIG. 1 illustrates adapter card 108 positioned over motherboard 102, it is not intended to limit the embodiments herein. In some embodiments, the adapter card 108 may be positioned adjacent to the motherboard 102. In some embodiments, the adapter card 108 may be positioned adjacent or over other components within computing device 100, such as a system fan. In some embodiments, the adapter card 108 may be integrated into the motherboard 102. For example, the adapter card 108 may be integrated as a local area network on the motherboard 102 (LOM).

In some embodiments, the adapter card 108 is coupled to the motherboard interface module 104 via a channel 106. In some embodiments, the channel 106 may be a flex cable that transmits data between the adapter card 108 and the motherboard interface module 104. In some embodiments, the channel 106 may be a ribbon cable, a round cable or an electrical cable, to name a few, that can facilitate and transmit data between the adapter card 108 and the motherboard interface module 104. In some embodiments, the channel 106 may be configured to transmit data using a PCIe, PCI, PCI-X, or any protocol compatible to use with the motherboard interface module 104 and adapter card 108.

In some embodiments, the motherboard interface module 104 is coupled to the adapter card 108 via the channel 106 at one end 112 of module 104 and further coupled to motherboard 102 at another end 114 of module 104. In some embodiments, the ends 112 and 114 may be electrical connectors that may be coupled to the channel 106 and the motherboard 102, respectively. In some embodiments, the end 114 of motherboard interface module 104 may be indirectly connected to the mother board 102. For example, end 114 may be connected to a local bus (not shown) to communicate with the motherboard 102.

In some embodiments, the motherboard interface module 104 may be an express miniboard. It is appreciated that an express miniboard is conventionally used as a wireless network adapter in computing devices. However, in this example, the express miniboard is an interface for transmitting data between the motherboard 102 and the adapter card 108. In some embodiments, the motherboard interface module 104 may be an express card or any interface module configured to facilitate data communication between the motherboard 102 and the adapter card 108.

In some embodiments, the motherboard interface module 104 may transmit data such as, processing data, clocking data to synchronize data between the motherboard 102 and adapter card 108, and data related to the features provided by the adapter card 108. In some embodiments, the motherboard interface module 104 is configured to supply power, current and/or voltage to the adapter card 108 to allow the adapter card to function and to communicate with the motherboard 102.

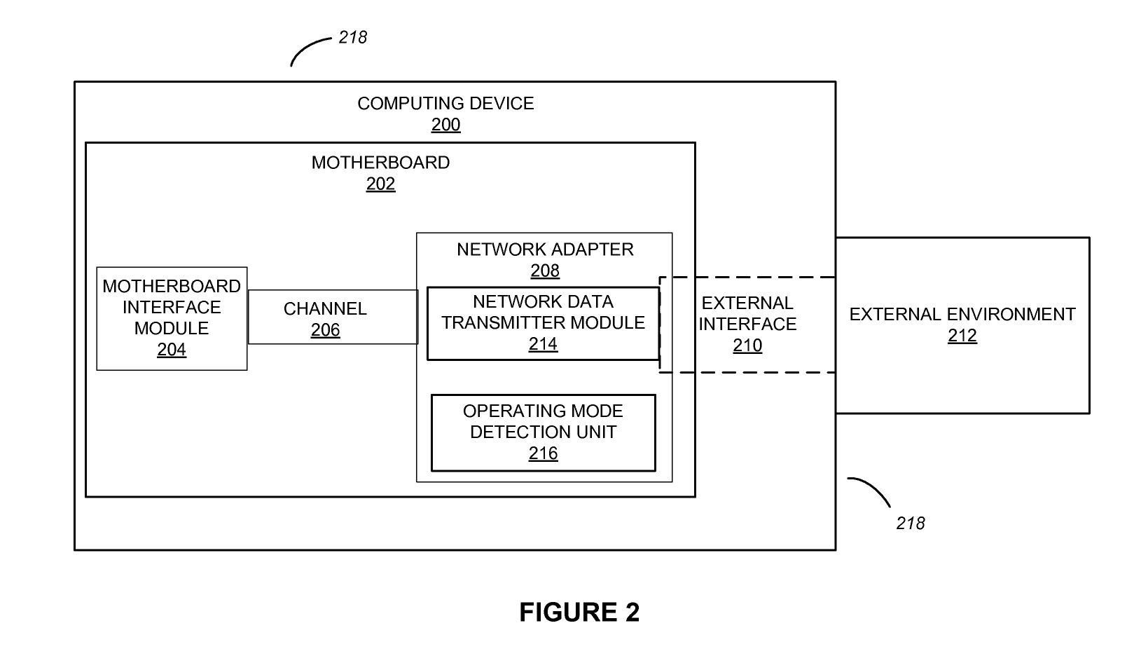

Referring now to FIG. 2, a computing device configured to house a network adapter according to one embodiment is shown. The computing device 200 includes a motherboard 202, a motherboard interface module 204, a channel 206, a network adapter 208, and an external interface 210 (depicted in dotted lines). In some embodiments, motherboard 202, motherboard interface module 204 and channel 206 may be substantially similar to the motherboard 102, the motherboard interface module 104, and channel 106 as described in FIG. 1, respectively.

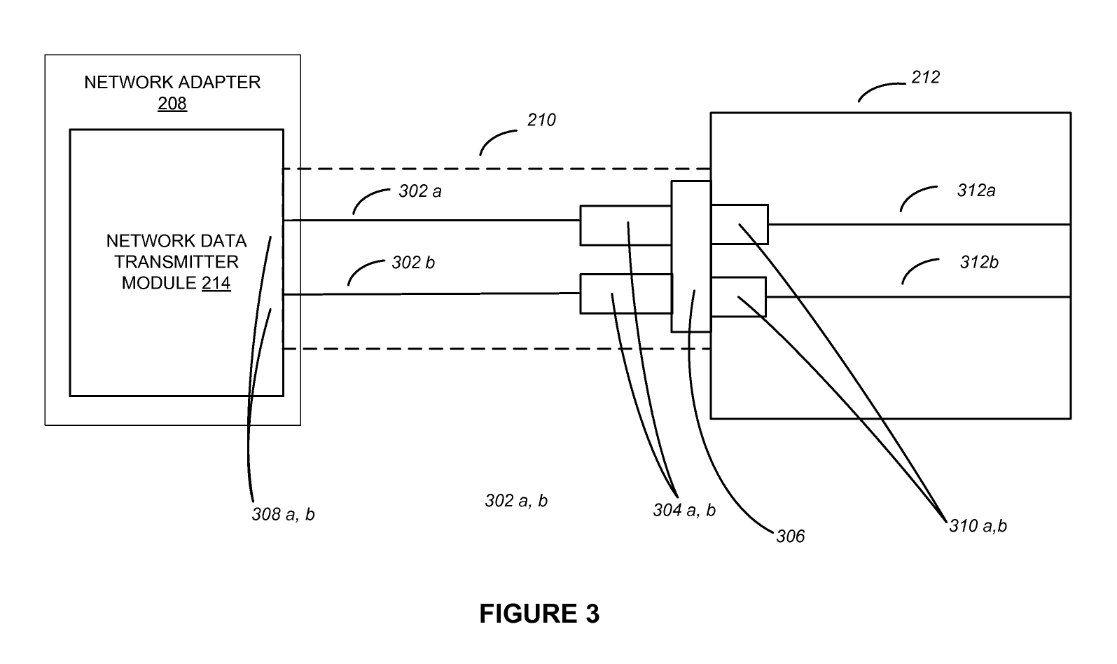

FIG. 2 illustrates incorporating the network adapter 208 in computing device 200 without using a PCI slot. In some embodiments, the network adapter 208 may be incorporated in the computing device 200 in a similar topology as described in FIG. 1 except that the network adapter is communicatively coupled to the external interface 210. The external interface 210 may be configured to couple the network adapter 208 to an external environment 212 to facilitate data communication between the network adapter 208 and the external environment 212, which is further described below in FIG. 3.

Referring back to the network adapter 208, the network adapter 208 may be a fiber optics adapter in some embodiments. In some embodiments, the network adapter 208 may be a copper wire adapter. In some embodiments, the network adapter 208 may include a network data transmitter module 214 and an operating mode detection unit 216.

In some embodiments, the network data transmitter module 214 may be configured to communicate networking data between the external environment 212 (e.g., a computer network) and the network adapter 208 by emitting light signals. In some embodiments, the network data transmitter module 214 is configured to receive electrical signals from the motherboard interface module 204 via channel 206 and convert the electrical signals into light signals. Subsequently, the light signals may be transmitted to the external environment 212.

Conventional network adapters include a built in network interface that may be used to connect to an external environment, e.g., sockets for a user to plug in a fiber optic cable. As such, when a conventional network adapter is inserted into a PCI slot, the network interface protrudes from a sidewall of the computing device to allow a user to connect, for instance, an Ethernet cable therein. However, as illustrated in FIG. 2, the network adapter 208 is not inserted into a PCI slot, and thus, a network interface is not available at a sidewall 218 to establish a direct connection to the external environment 212. Instead, in some embodiments, the network adapter 208 may be coupled to an external interface 210 (that is a non-PCI slot) configured to transmit data between the network adapter 208 and the external environment 212, as described further below in FIG. 3.

In some embodiments, the operating mode detection unit 216 is configured to determine an operating state, such as an on state or an off state of the computing device 200. Based on the operating state of the computing device 200, the operating mode detection unit 216 determines whether to perform a WoL operation.

It is appreciated that in order to provide the functionalities that are supported by PCI slots without using PCI slots, certain modifications to a network adapter may be made. In FIG. 2, to support the WoL feature, the network adapter 208 includes the operating mode detection unit 216. As noted above, the operating mode detection unit 216 determines the operating state of the computing device 200 and determines whether to perform a WoL operation.

Conventionally, a PCI slot supplies a network adapter with either 3.3 volts (V) or 0V based on an operating state of a device. For instance, if the device is an on-state, then the PCI slot supplies the network adapter with 3.3V and 0V while the device is in an off-state. Based on the presence of a 3.3V or a 0V, the network adapter may be configured to perform a WoL operation to allow a system administrator to remotely access the device.

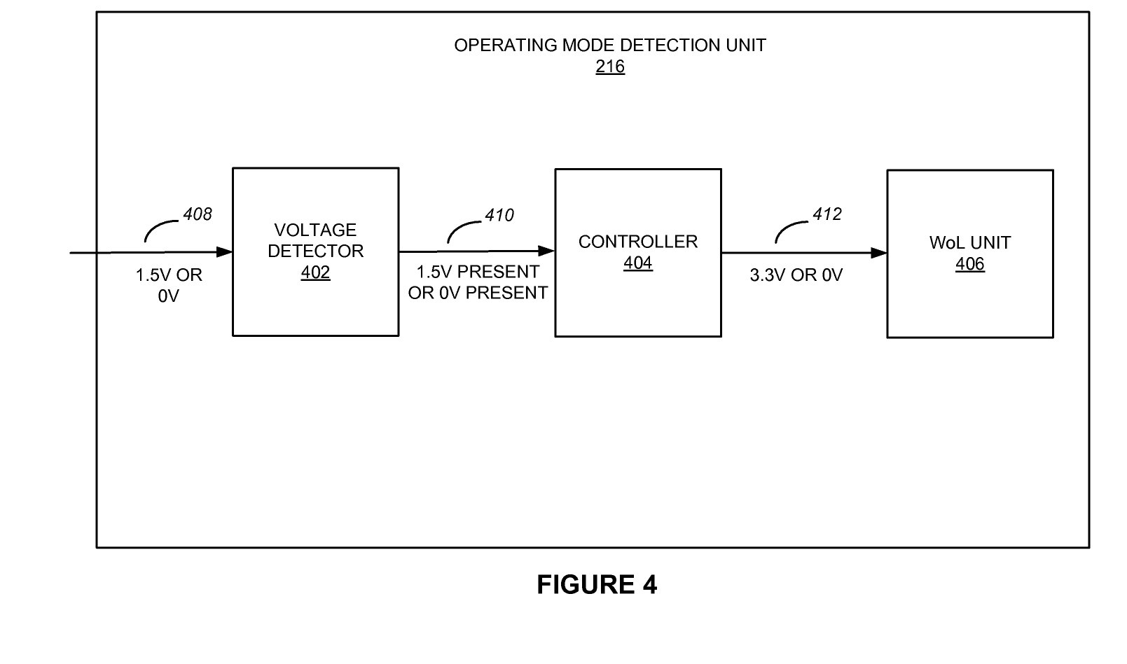

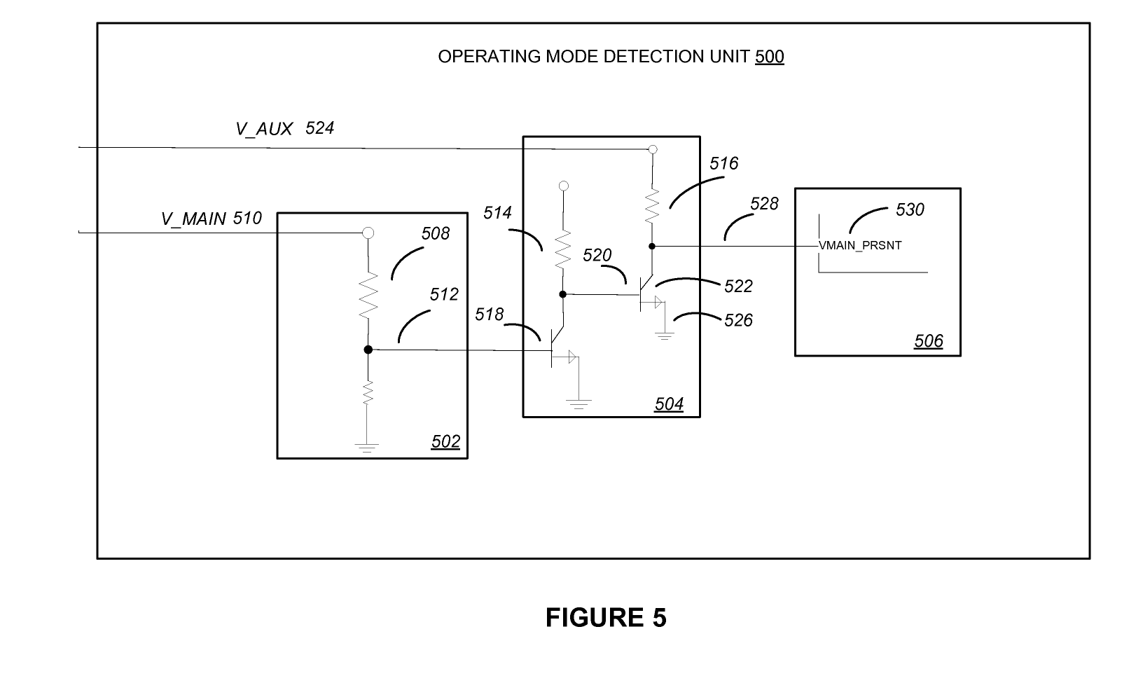

However, without inserting the network adapter 208 in a PCI slot, the network adapter 208 may not be supplied with a 3.3V or 0V to initiate a WoL operation. In some embodiments, the motherboard interface module 204 may be an express miniboard that is configured to supply a 1.5V or 0V to the network adapter 208. As such, in this embodiment, the network adapter 208 is not supplied with the expected 3.3V or 0V to determine whether to initiate a WoL operation. To facilitate WoL features in the network adapter 208, the operating mode detection unit 216 is used to determine the operating state of computing device 200 as described further below in FIGS. 4 and 5.

Referring now to FIG. 3, an external interface according to one embodiment is shown. In some embodiments, the external interface 210 may include media cables 302a and 302b, connectors 304a and 304b, and an external socket 306. In some embodiments, the media cables 302a and 302b may be fiber optic strands, copper wire strands, Ethernet cables, or some media cables to communicate networking data between the network adapter 208 and the external environment 212 via the external socket 306. In one embodiment, media cable 302a may be configured to receive networking data, while media cable 302b may be configured to transmit networking data from the network adapter 208 to the external environment 212, or vice versa. In some embodiments, both media cables 302a and 302b may be bidirectional and configured to receive and transmit networking data. Although FIG. 3 illustrates two media cables 302a and 302b, it is appreciated that any number of media cables may be used.

In some embodiments, the media cables 302a and 302b may be coupled to the network adapter 208 at ends 308a and 308b. In some instances, ends 308a and 308b may integrated within the network data transmitter module 214 by, for instance, soldering the media cables 308a and 308b into the network data transmitter module 214. In some instances, the ends 308a and 308b may be inserted into connectors or sockets (not shown) on the network data transmitter module 214.

In some embodiments, the media cables 302a and 302b are coupled to connectors 304a and 304b, which are coupled to the external socket 306. The external socket 306 may be configured to allow the media cables 302a and 302b to be communicatively coupled with the external environment 212. In some embodiments, external socket 306 may include sockets 304a and 304b to insert the media cables 302a and 302b therein. The external socket 306 may further include sockets 310a and 310b protruding on the outside of a wall for coupling to the external cables 312a and 312b. In some embodiments, the external cables 312a and 312b may be fiber optic cables, copper wire cables, Ethernet cables or some other cables connected to a computer network. It is appreciated that the components depicted within the external interface 210 are exemplary and not intended to limit the scope of the embodiments. For example, in some embodiments, the external interface may be a connector that is coupled to the network data transmitter module 214 at one end and includes sockets at another end to insert external cables 312a and 312b. As FIG. 3 illustrates, by using an external interface 210, a computing device can incorporate the features of the network adapter 208 without the use of a PCI slot.

Referring now to FIG. 4, an operating mode detection unit according to one embodiment is shown. The operating mode detection unit may include a voltage detector 402, a controller unit 404, and a WoL unit 406. The voltage detector 402 may detect the voltage present from the motherboard. The controller unit 404 may change the detected voltage to an expected voltage value for supporting the WoL feature. For example, WoL feature is initiated if a 0V is detected and is off if a 3.3V is detected. As such, the controller unit 404 may change the detected high voltage of 1.5V from the thin client to 3.3V and maintain the voltage at 0V if a less than 1.5V is detected, e.g., if a 0V is detected. Accordingly, the WoL unit 406 initiates a WoL functionality if it receives a 0V signal and it will not initiate the WoL functionality if it receives a signal with a 3.3V. It is appreciated that other functionalities and features may have a different voltage supplied to the adapter card from the motherboard in comparison to the PCI slot. As such, the controller unit 404 may similarly adjust the detected voltages from the motherboard in order to make them compatible with the expected voltage value of the functional units of the adapter card.

Operating mode detection unit 216 of FIG. 4 is described with reference to the computing device 200, network adapter 208 and the motherboard interface module 204 of FIG. 2. To further illustrate features of the operating mode detection unit 216, the motherboard interface module 204 is described as an express miniboard as described herein. It is appreciated that the disclosure of the operating mode detection unit 216 with reference to the computing device 200, the network adapter 208 and an express miniboard is exemplary and is not intended to limit the scope of the embodiments.

As noted above, the network adapter 208 includes the operating mode detection unit 216 to facilitate the WoL feature for the network adapter 208 by supplying the expected voltages 3.3V or 0V to initiate the WoL operation. In some embodiments, the operating mode detection unit may be configured to determine the amount of voltage supplied by a motherboard interface, change the voltage to an expected voltage, determine the operating state of the computing device, and initiate a WoL operation accordingly.

In some embodiments, the voltage detector 402, the controller unit 404 and the WoL unit 406 may be a combination of field effect transistors (FET), bipolar transistors, capacitors, inductors, and/or resistors to determine the operating state of computing device 200 of FIG. 2. In some embodiments, the voltage detector 402, the controller unit 404 and the WoL unit 406 may be a combination of circuitry and programming logic such as a programmable field gate arrays.

In some embodiments, the voltage detector 402 is configured to determine whether a specific voltage or voltages are present at motherboard interface. In some embodiments, voltage detector 402 may receive a voltage from the express miniboard that connects the motherboard 202 and the network adapter 208. In this example, the express miniboard supplies a voltage 408 of 1.5V when the computing device is in an on state, and 0V when the computing device is in an off state.

According to one embodiment, the detected voltage is communicated to the controller unit 404. In some embodiments, the voltage detector 402 may transmit a signal to controller unit 404 to indicate the presence of either the 1.5V or the 0V. For example, if the voltage detector 402 determines that 1.5V is received from the express miniboard, the voltage detector 402 sends a signal 410 having a certain value, e.g., one, to controller unit 404 indicating that 1.5V is present. Otherwise, if 0V is received, then the voltage detector 402 sends a signal 410 having another value, e.g., zero, indicating that 0V is present. In one embodiment, the transmitted signal 410 may be the detected voltage, e.g., 1.5V or 0V.

In some embodiments, the controller unit 404 is configured to change the voltage 408 received from the express miniboard based on the signal 410 received from the voltage detector 402. In some embodiments, if the controller unit 404 receives 1.5V from the voltage detector 402, then the controller unit 404 changes the voltage from 1.5V to 3.3V and supplies the 3.3V to the WoL unit 406 via connection 412. On the other hand, if the controller unit 404 receives 0V from the voltage detector 402, then the controller unit 404 may maintain the voltage at 0V and supply the 0V to the WoL unit 406.

In some embodiments, the controller unit 404 may include switches, resistors, transistors and amplifiers to change the voltage 408 based on the determination of voltage detector 402. In some embodiments, the controller unit 404 may include programming logic that determines and changes the voltage 408 to a predetermined voltage as described herein. In one embodiment, a buck circuitry may be used to implement the controller unit 404.

In some embodiments, the WoL unit 406 may be a network controller, similar to a network controller provided by Broadcom®. According to one embodiment, the WoL unit 406 facilitates WoL functionality.

In some embodiments, the WoL unit 406 is configured to determine whether a computing device is an on state or in an off state in response to the received voltage 412 from the controller unit 404. For example, if 3.3V is received, then the WoL unit 406 may determine that the computing device is in an on state. In some embodiments, if it is determined that the computing device is in an on state, then the WoL unit 406 may not initiate a WoL operation.

On the other hand, if 0V is received, then the WoL unit 406 determines that the computing system is in an off state. In some embodiments, if it is determined that the computing device is in an off-state, then the WoL unit 406 initiates a WoL operation. For example, the WoL unit 406 may allow a remote computing device to send packets to the computing device to change the computing device from an off state to a WoL state, thereby allowing the computing device 200 to be accessed remotely.

It is appreciated that the specific numbers provided are exemplary and for illustration purposes only and are not intended to limit the scope of the embodiment. For example, embodiments described herein, cover functionalities and features that use voltages different from 0V, 1.5V, and 3.3V. For example, a feature of an adapter card supported by a PCI slot may use 1V and 2V. In this example, the express miniboard may supply 0V and 0.5V to the adapter card from the motherboard. As such, the detected voltages from the motherboard may similarly be adjusted to 1V and 2V respectively to support the feature of the adapter card. Further, it is appreciated that the embodiments cover ranges of voltages.

Referring now to FIG. 5, an operating mode detection unit according to one embodiment is shown. In some embodiments, the operating mode detection unit 500 may function in a substantially similar manner as operating mode detection unit 216 as described in FIGS. 2 and 4. In some embodiments, the operating mode detection unit 500 includes circuits 502, 504, and 506. It is appreciated that the circuits described in FIG. 5 are exemplary and are not intended to limit the embodiments. For instance, circuits 502, 504, and 506 may be a combination of field effect transistors (FET), bipolar transistors, capacitors, inductors, and/or resistors that may be used to initiate a WoL operation in an adapter card.

In some embodiments, circuit 502 may function in a substantially similar manner as the voltage detector 402 of FIG. 4. In this example, circuit 502 includes a resistor 508 that is coupled to a main voltage over a V_MAIN bus 510. In some embodiments, the circuit 502 receives the main voltage from a motherboard interface module, such as an express miniboard of a computing device as described herein. For example, the motherboard interface may supply 1.5V to circuit 502 via the V_MAIN bus 510 when the computing device is an on state, thereby applying a non-zero voltage at gate 512. When the computing device is in an off-state, the motherboard interface may supply 0V, thereby applying 0V to across gate 512.

In some embodiments, circuit 504 may function in a substantially similar manner as controller unit 404 of FIG. 4. Circuit 504 includes resistors 514 and 516, and transistors 518 and 522. In some embodiments, the gate 512 of the transistor 518 is coupled to circuit 502. In some embodiments, the gate 520 of the transistor 522 is coupled to the collector of transistor 518 while its collector is coupled to a V_AUX bus 524 via the resistor 516 and its emitter is coupled to ground 526.

In some embodiments, the switch 518 closes if a voltage, e.g., 1.5V, is present at the gate 512 of the transistor 518. Otherwise, the switch 518 may open if a 0V is detected at the gate 512. The switch 522 opens if the switch 518 is closed and the switch 522 closes if the switch 518 opens. Accordingly, when the switch 518 opens and the switch 522 closes, the voltage from V_AUX bus 524 will be across connection 528. On other hand, when the switch 518 closes and the switch 522 opens, the voltage across the connection 528 will be 0V. In other words, when the system is in off mode the voltage across 528 is 0V and when the system is in on mode the voltage across 528 is 3.3V as expected when a PCI slot is used even though here no PCI slot is used. Accordingly, the circuit 506 facilitates WoL features as if a PCI slot was used. Circuit 506 functions substantially similar to the WoL unit 406. In some embodiments, circuit 506 may include a VMAIN_PRSNT pin 530 that is configured to determine whether a specific voltage or voltages are present. For example, if a predetermined voltage, such as 3.3V, is present at VMAIN_PRSNT pin 530, then it is determined that a computing device is an on state and a WoL operation may not be initiated (circuitry not shown). On the other hand, if 0V is present at VMAIN_PRSNT pin 530, then it is determined that the computing device is in an off state and a WoL operation may be initiated.

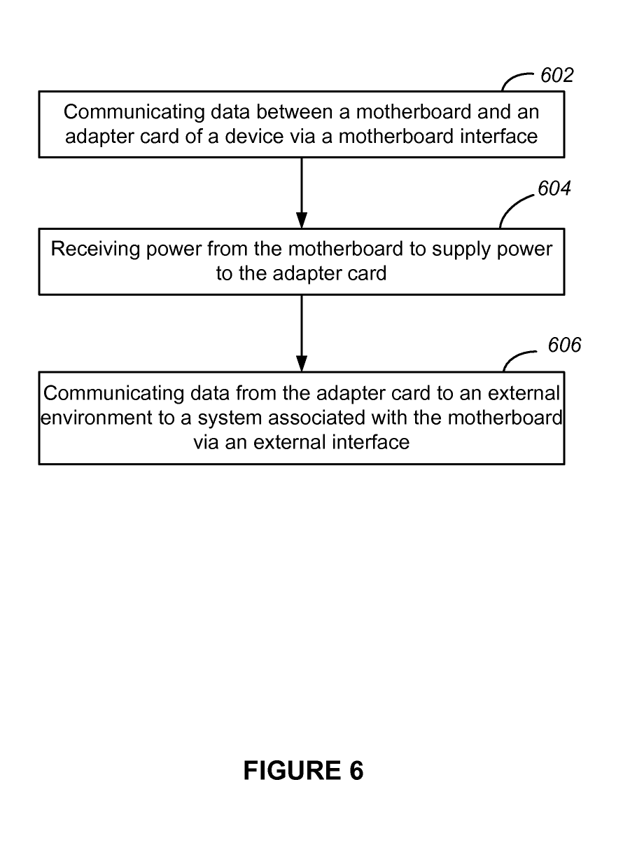

Referring now to FIG. 6, an exemplary flow diagram for data communication of an adapter card according to one embodiment is shown. At step 602, data between a motherboard and an adapter card of a device is communicated via a motherboard interface. In some embodiments, the motherboard may be similar to the motherboards 102 and 202 of FIGS. 1 and 2, respectively. In some embodiments, the adapter card may be similar to the adapter card 108 of FIG. 1 and the network adapter 208 of FIG. 2. In some embodiments, the adapter card may be a fiber optics adapter, a graphics card, a network adapter, a sound card, or any peripheral component that is conventionally inserted into a PCI slot. In some embodiments, the adapter card may be a component of a thin client computing device.

The motherboard interface may be similar to the motherboard interface modules 104 and 204 of FIGS. 1 and 2, respectively, in some embodiments. In some instances, the motherboard interface may be an express miniboard. The mother board interface may communicate data using a PCIe, PCI, PCI-X, or any protocol compatible with the motherboard interface and the adapter card. In some embodiments, the data communicated between the motherboard and the adapter card may be processing data, clocking data and other data to utilize features of the adapter card.

At step 604, power is received from the motherboard to power the adapter card. In some embodiments, the power is received by a motherboard interface, such as the motherboard interface module 104 and 204 of FIGS. 1 and 2, and it supplies the power to an adapter card. In some embodiments, the motherboard interface receives the power from the motherboard and transmits the power over a connection, such as channels 106 and 206 of FIGS. 1 and 2, to the adapter card.

In some embodiments, the motherboard interface module may receive and transmit a voltage to the adapter card to use certain features of the adapter card. For example, the motherboard interface module may transmit certain voltages to an operating mode detection unit of an adapter card, such as the operating mode detection unit described in FIGS. 2, 4 and 5, to initiate a WoL operation.

At step 606, data from the adapter card is communicated to an external environment to a system associated with the motherboard via an external interface. In some embodiments, the adapter card may communicate networking data to an external environment, such as a computer network. In some embodiments, the adapter card may comprise a fiber optics module that communicates networking data to the external environment by emitting light signals.

In some embodiments, the adapter card communicates data via the external interface. In some embodiments, the external interface is a non-PCI slot configured to communicate data between the adapter card and the external environment. In some embodiments, the external interface is substantially similar to the external interface 210 of FIGS. 2-3.

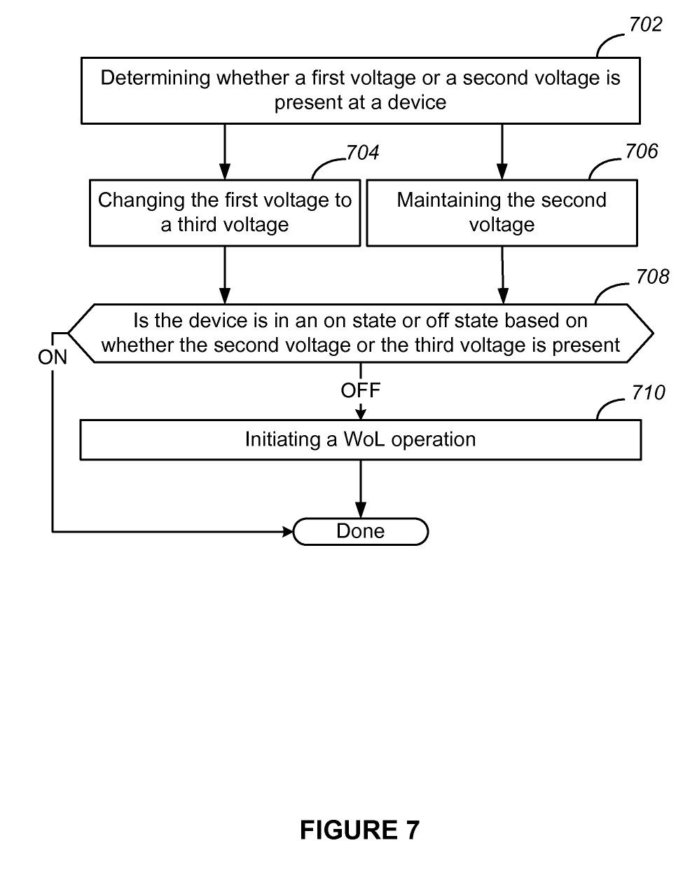

Referring now to FIG. 7, an exemplary flow diagram to determine an operational state of a computing device to initiate a wake on local access network (WoL) operation according to one embodiment is shown. In some embodiments, parts or all of method 700 may be performed by a operating mode detection unit of an adapter card as described in FIG. 2 and FIGS. 4-5.

At step 702, it is determined whether a first voltage or a second voltage is present at a device. In some embodiments, a voltage detector of a operating mode detection unit, such as the voltage detector described in FIGS. 4-5, may determine whether a first voltage or a second voltage is present at a motherboard interface. For example, if the motherboard interface is an express miniboard, then the voltage detector may determine whether a 1.5V or a 0V is present at the express miniboard. In some embodiments, if it determined that a first voltage (e.g., 1.5V) is present, then method 700 proceeds to step 704. Otherwise, if it is determined that a second voltage (e.g., 0V) is present, then method 700 proceeds to step 706.

At step 704, the first voltage is changed to a third voltage in response to a determination at step 702 that the first voltage is present. In some embodiments, a controller unit, such as the controller unit described in FIGS. 4-5, may change the first voltage to a third voltage. For example, if it is determined that 1.5V is present at a motherboard interface, then the controller unit may change the 1.5V to a predetermined voltage, such as 3.3V, to utilize a WoL feature of an adapter card.

At step 706, a second voltage is maintained in response to a determination at step 702 that the second voltage is present. For example, if it is determined that 0V is present at motherboard interface, then the controller unit may maintain the 0V to determine the operating state of a device. In another example, the controller unit may change the 0V to a predetermined voltage that falls within a certain range, such as a voltage less than or equal to 0.8V. In some embodiments, the second voltage may be changed to a fourth voltage in a substantially similar manner as described in FIGS. 4-5.

At step 708, it is determined whether the device is in an on state or an off state based on whether the second voltage or a third voltage is present or alternatively based on the value of the first voltage and the second voltage. In some embodiments, a WoL unit, such as the WoL units of FIGS. 4-5, may determine whether the device is in an on state or an off state. For instance, if it is determined that a third voltage (e.g., 3.3V) is present, then it may be determined that the device is in an on state. If it is determined that the device is in an on state, then it may be determined that a WoL operation does not need to be initiated and method 700 may end.

In some embodiments, if it is determined that second voltage (e.g., 0V) is present, then it may be determined that the device is in an off state. Then, method 700 proceeds to step 710 to initiate a WoL operation. At step 710, the WoL operation may be initiated by changing the device from an off state to a WoL state to receive networking data packets to allow remote access of the device.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed:

1. A device comprising:
an adapter card;
a motherboard interface for coupling said adapter card to a motherboard, wherein said motherboard interface is configured to transmit data between said adapter card and said motherboard, and wherein said motherboard interface is configured to supply power from said motherboard to said adapter card; and
an external interface for coupling said adapter card to an external environment of a system associated with said motherboard, wherein said external interface is a non-peripheral connect interface (PCI) slot, and wherein said external interface is configured to transmit data between said external environment of said system and said adapter card.

2. The device of claim 1, wherein said adapter card comprises:
a network data transmitter module configured to communicate networking data between said external environment of said system and said adapter card via emitting light signals.

3. The device of claim 1, wherein said adapter card comprises a fiber optic module.

4. The device of claim 1, wherein said adapter card comprises a operating mode detection unit configured to determine an operating state of said motherboard.

5. The device of claim 1, wherein said motherboard interface comprises an express miniboard.

6. The device of claim 1, wherein said adapter card comprises a component configured to determine whether to perform a wake on local access network (WoL) operation.

7. The device of claim 1, wherein said adapter card comprises:
a voltage detector configured to determine whether a first voltage or a second voltage is present at said motherboard interface;
a controller unit configured to change said first voltage to a third voltage in response to determining the presence of said first voltage, wherein said first voltage differs from said third voltage, and wherein said controller unit is configured to maintain said second voltage in response to detection of said second voltage by said voltage detector; and
a wake on local access network (WoL) unit configured to initiate a WoL operation in response to receiving said second voltage and wherein said WoL unit is configured to disable said WoL operation in response to receiving said third voltage from said controller unit.

8. The device of claim 7, wherein said adapter card is configured to determine whether said motherboard is in an on state or an off state, and wherein said adapter card is further configured to initiate a wake on local access network (WoL) operation in response to determining that said motherboard is in said off state.

9. The device of claim 1, wherein said adapter card is positioned in a non-PCI slot location.

10. A method comprising:
communicating data between a motherboard and an adapter card of a device via a motherboard interface;
receiving power from said motherboard to supply power said adapter card; and
communicating data between said adapter card and an external environment to a system associated with said motherboard via an external interface, wherein said external interface is a non-peripheral connect interface (PCI) slot.

11. The method of claim 10 further comprising:
emitting light signals to communicate networking data between said adapter card and said external environment.

12. The method of claim 10 further comprising:
determining an operating state associated with said motherboard; and
determining whether to perform a wake on local access network (WoL) operation based on said operating state.

13. The method of claim 10 further comprising:
determining whether a first voltage or second voltage is present at said motherboard coupled to said motherboard interface;
changing said first voltage to a third voltage in response to determining presence of said first voltage, wherein said first voltage differs from said third voltage;
maintaining said second voltage in response to determining presence of said second voltage; and
initiating a wake on local access network (WoL) operation in response to determining presence of said second voltage.

14. The method of claim 10 further comprising:
determining that said device is in an on state responsive to detecting a first voltage level at said motherboard interface coupled to said motherboard; and
determining that said device is in an off state responsive to detecting a second voltage level at said motherboard interface coupled to said motherboard.

15. The method of claim 10, wherein said motherboard interface is an express miniboard.

16. A device comprising:
a peripheral component configured to be positioned in a non-peripheral connect interface (PCI) slot location, wherein said peripheral component facilitates communication between a system and an external environment, wherein said system comprises a motherboard associated with said device, and wherein said external environment is an environment external to said system; and
a motherboard interface configured to couple said peripheral component to said motherboard, wherein said motherboard interface is configured to communicate data between said peripheral component and said motherboard, and wherein said motherboard interface is configured to supply power to said peripheral component.

17. The device of claim 16 further comprising:
an external interface for coupling said peripheral component to said external environment, wherein said external interface is a non-peripheral connect interface (PCI) slot, and wherein said external interface is configured to communicate data between said external environment and said peripheral component.

18. The device of claim 16, wherein said motherboard interface comprises an express miniboard.

19. The device of claim 16, wherein said peripheral component comprises:
a voltage detector configured to determine whether a first voltage or a second voltage is present at said motherboard interface;
a controller unit configured to change said first voltage to a third voltage in response to determining the presence of said first voltage, wherein said first voltage differs from said third voltage, and wherein said controller unit is configured to maintain said second voltage in response to detection of said second voltage by said voltage detector; and
a wake on local access network (WoL) unit configured to initiate a WoL operation in response to receiving said second voltage and wherein said WoL unit is configured to disable said WoL operation in response to receiving said third voltage from said controller unit.

20. The device of claim 19, wherein said peripheral component is configured to determine whether said motherboard is in an on state or an off state, and wherein said peripheral component is further configured to initiate a wake on local access network (WoL) operation in response to determining that said motherboard is in said off state.
